(19) United States
(12) Patent Application Publication
(10) Pub. No.: US 2015/0168983 A1
(43) Pub. Date: Jun. 18, 2015

(54) POWER CONVERSION DEVICE, ISOLATED DRIVING CIRCUIT, AND ISOLATED DRIVING METHOD

(71) Applicant: Delta Electronics (Shanghai) Co., Ltd., Shanghai (CN)

(72) Inventors: Yun-Hui CHEN, Shanghai (CN); Guo-Dong YIN, Shanghai (CN); Zhong-Wei KE, Shanghai (CN)

(21) Appl. No.: 14/571,253

(22) Filed: Dec. 15, 2014

(30) Foreign Application Priority Data
Dec. 17, 2013 (CN) 201310692485.0

(51) Int. Cl. G05F 5/00

(52) U.S. Cl. CPC G05F 5/00

(57) ABSTRACT

A power conversion device, an isolated driving circuit, and an isolated driving method are disclosed herein. The isolated driving circuit includes a control module, a transformer, a rectifying circuit, and a driving auxiliary circuit. The control module is configured to generate a first pulse width modulation (PWM) signal and a second PWM signal according to the output signal. The transformer is configured to receive the first and second pulse PWM signals to generate a first control signal. The rectifying circuit is configured to generate a second control signal according to the first control signal. The driving auxiliary circuit is configured to generate a driving control signal according to the second control signal to drive the at least one power switch.

### RELATED APPLICATIONS

This application claims priority to China Application Serial Number 201310692485.0 filed Dec. 17, 2013, which is herein incorporated by reference.

### BACKGROUND

1. Technical Field

The present disclosure relates to a power converter. More particularly, the present disclosure relates to a power converter with an isolated driving circuit and an isolated driving method thereof.

2. Description of Related Art

Reference is made to FIG. 1. FIG. 1 is a schematic diagram of a driving circuit 120 used in some approaches. The driving circuit 120 is configured to generate a control signal to control at least one power switch (not shown) of a power converter 100. The power converter 100 includes a reference ground GND (i.e., the ground terminal of an output signal VOUT) and a driving ground GND_P, in which the voltage level of the driving ground GND_P is floating with respect to the reference ground GND. A common driving circuit 120 includes a controller 122, a floating ground driver 124, and a floating ground voltage supply circuit 126. The controller 122 is configured to generate a control signal VCTRL according to the output signal VOUT of the power converter 100, and controller 122 is electrically connected to the output end of the power converter 100. Since the driving ground GND_P of the at least one power switch of the power converter 100 is floating, the controller 122 is not able to control the power switch of the power converter 100 directly. Thus, the floating ground driver 124 is utilized to isolate drive the power converter 100. In practical applications, the floating ground driver 124 requires two supply voltages for supply to the circuits corresponding to the reference ground GND and the driving ground GND_P, respectively. Hence, the floating ground voltage supply circuit 126 is utilized to generate a supply voltage VCP1 (i.e., the left side of the dashed line), in which the ground of the supply voltage VCP1 is the reference ground GND, and a supply voltage VCP2 (i.e., the right side of the dashed line), in which the ground of the supply voltage VCP2 is the driving ground GND_P.

However, the cost of the floating ground driver 124 is typically high. Moreover, since the floating ground voltage supply circuit 126 requires two different supply voltages, its circuitry is complex, especially for that of the power converter with multiple driving signals.

Therefore, a heretofore-unaddressed need exists to deal with the aforementioned deficiencies and inadequacies.

### SUMMARY

One aspect of the present disclosure provides an isolated driving circuit. The isolated driving circuit is configured to drive a power converter, in which the power converter includes a driving ground, a reference ground, and at least one power switch. The power converter is configured to generate an output signal according to an input signal, the output signal is electrically coupled to the reference ground, and the at least one power switch is electrically coupled to the driving ground. The isolated driving circuit includes a control module, a transformer, a rectifying circuit, and a driving auxiliary circuit. The control module is configured to generate a first pulse width modulation signal and a second pulse width modulation signal according to the output signal. The transformer is configured to receive the first pulse width modulation signal and the second pulse width modulation signal to generate a first control signal. The rectifying circuit is configured to generate a second control signal according to the first control signal. The driving auxiliary circuit is configured to generate a driving control signal according to the second control signal, so as to drive the at least one power switch.

Another aspect of the present disclosure provides a power conversion device. The power conversion device includes a power converter and an isolated driving circuit. The power converter is configured to generate an output signal according to an input signal. The power converter includes a power ground, a reference ground and at least one power switch, in which the output signal is electrically coupled to the reference ground and the at least one power switch is electrically coupled to the driving ground. When the voltage level of the driving voltage is at a first voltage level, the at least one power switch is turned on, and when the voltage level of the driving voltage is at a second voltage level, the at least one power switch is turned off.

Yet another aspect of the present disclosure is to provide an isolated driving method for driving a power converter having a driving ground and a reference ground, in which the power converter includes at least one power switch electrically coupled to the driving ground. The isolated driving method includes the following steps: generating a first control signal at a secondary side winding of a transformer by providing a first pulse width modulation signal and a second pulse width modulation signal to a primary side winding of the transformer, in which the first pulse width modulation signal is complementary to the second pulse width modulation signal; generating a second control signal by transmitting the first control signal to a rectifying circuit; and generating a driving control signal by transmitting the second control signal to a driving auxiliary circuit, so as to control the at least one power switch, in which the at least one power switch is turned on when the voltage level of the driving control signal is at a first voltage level, and the at least one power switch is turned off when the voltage level of the driving control signal is at a second voltage level.

In summary, the power conversion device, the isolated driving circuit, and the method thereof in the present disclosure are able to drive the power converter. As a result, the cost and complexity of the circuitry of the power conversion device are reduced.

These and other features, aspects, and advantages of the present disclosure will become better understood with reference to the following description and appended claims.

It is to be understood that both the foregoing general description and the following detailed description are by examples, and are intended to provide further explanation of the invention as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic diagram of a driving circuit used in some approaches;

FIG. 2A is a schematic diagram of an isolated driving circuit according to one embodiment of the present disclosure;

FIG. 2B is a schematic diagram of a power conversion device according to one embodiment of the present disclosure;

FIG. 2C is a graph illustrating the waveforms of a first control signal and a second control signal according to one embodiment of the present disclosure;

FIG. 2D is a schematic diagram of a buck converter according to one embodiment of the present disclosure;

FIG. 3A is a schematic diagram of a control module according to one embodiment of the present disclosure;

FIG. 3B is a schematic diagram of a sampling circuit according to one embodiment of the present disclosure;

FIG. 3C is a schematic diagram of the control module according to one embodiment of the present disclosure; and

FIG. 4 is a flow chart of an isolated driving method according to one embodiment of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

Although the terms “first,” “second,” etc., may be used herein to describe various elements, these elements should not be limited by these terms. These terms are used to distinguish one element from another.

As used herein, “around,” “about” or “approximately” shall generally mean within 20 percent, preferably within 10 percent, and more preferably within 5 percent of a given value or range. Numerical quantities given herein are approximate, meaning that the term “around,” “about” or “approximately” can be inferred if not expressly stated.

As used herein, the terms “comprising,” “including,” “having,” “containing,” “involving,” and the like are to be understood to be open-ended, i.e., to mean including but not limited to.

In this document, the term “coupled” may also be termed as “electrically coupled”, and the term “connected” may be termed as “electrically connected”. “Coupled” and “connected” may also be used to indicate that two or more elements cooperate or interact with each other.

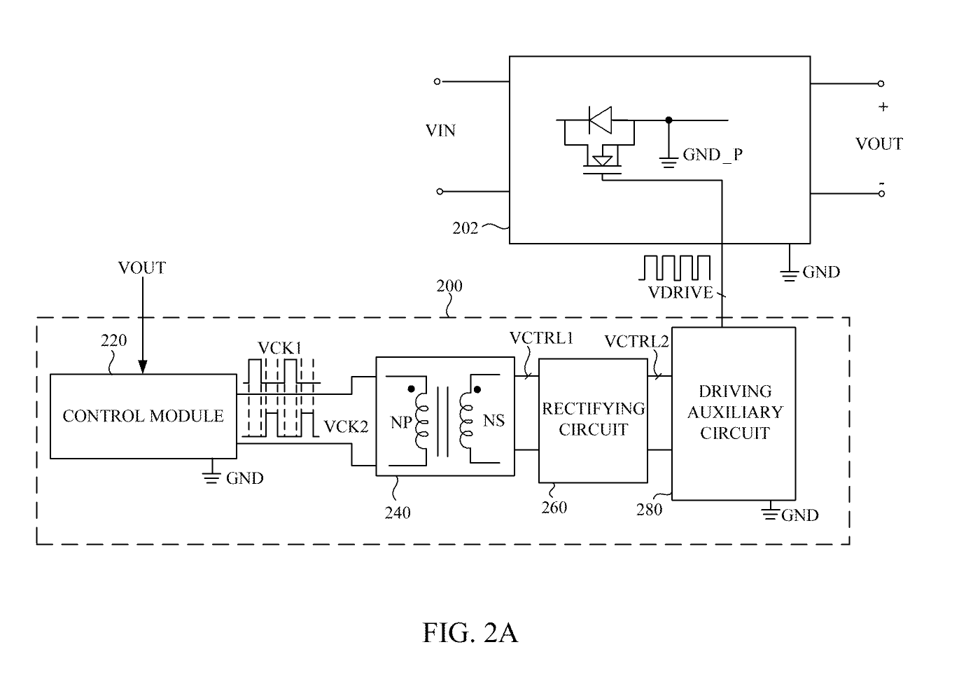

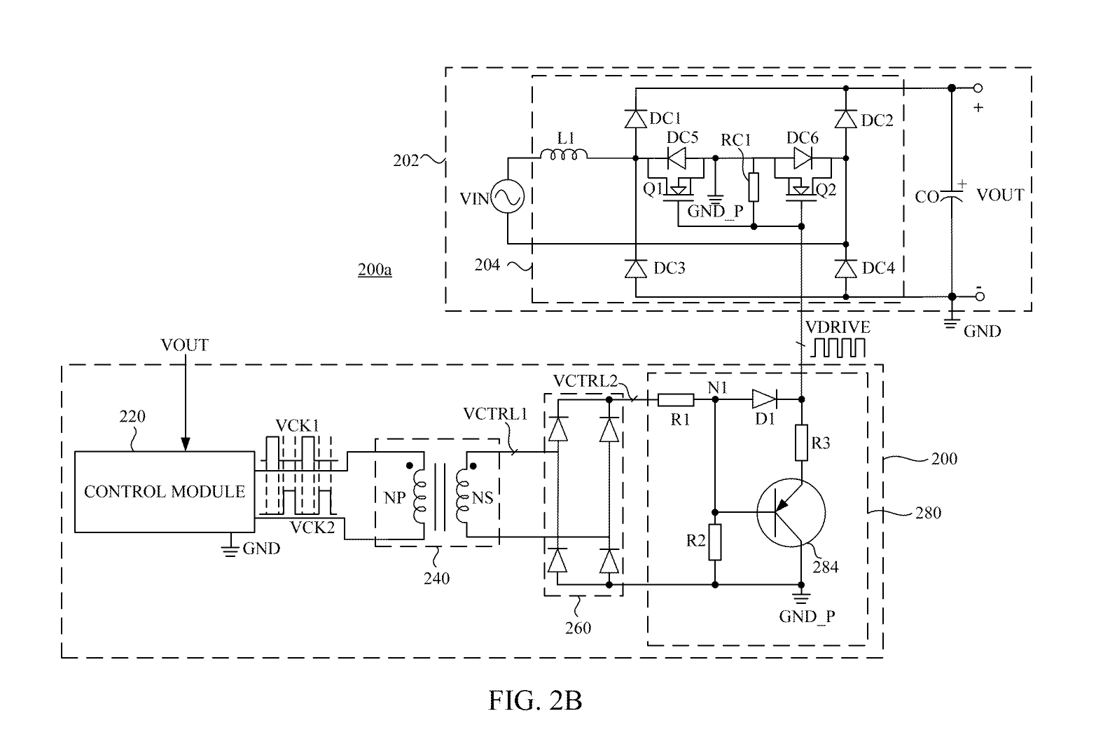

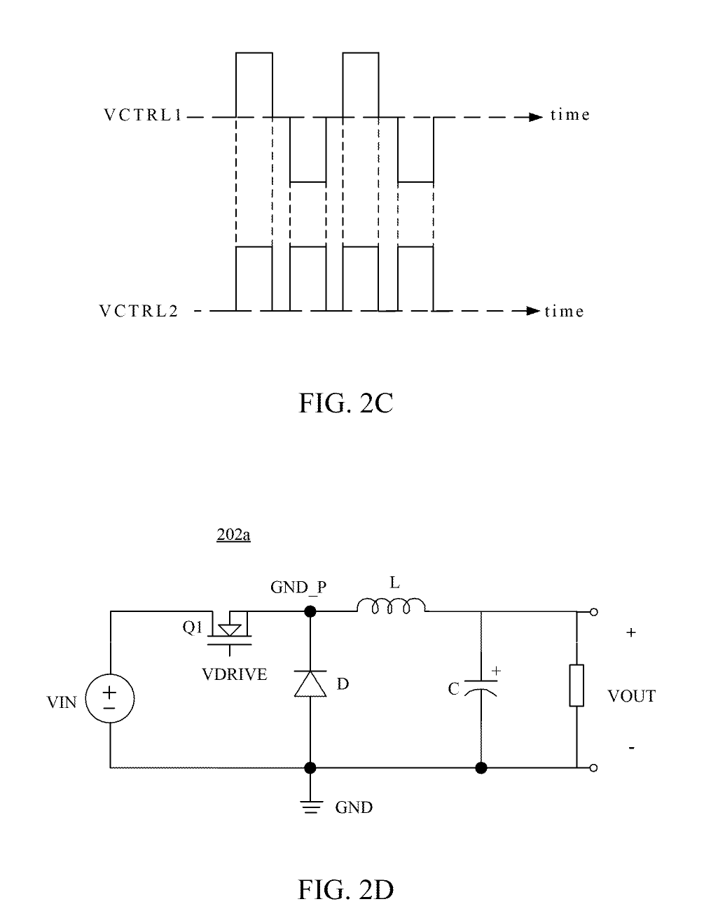

Reference is made to FIG. 2A. FIG. 2A is a schematic diagram of an isolated driving circuit 200 according to one embodiment of the present disclosure. As shown in FIG. 2A, the isolated driving circuit 200 is configured to drive a power converter 202. The power converter 202 includes a driving ground GND_P, a reference ground GND, and at least one power switch. The power converter 202 is configured to generate an output signal VOUT according to an input signal VIN, in which the at least one power switch is electrically coupled to the driving ground GND_P and the output signal VOUT is electrically coupled to the reference ground GND. The isolated driving circuit 200 includes a control module 220, a transformer 240, a rectifying circuit 260 and a driving auxiliary circuit 280.

The control module 220 is configured to generate a first pulse width modulation (PWM) signal VCK1 and a second PWM signal VCK2 according to the output signal VOUT generated from the power converter 202. The transformer 240 is configured to receive the first PWM signal VCK1 and the second PWM signal VCK2 and correspondingly generate a first control signal VCTRL1. Duty cycles of the first PWM signal VCK1 and the second PWM signal VCK2 may be both less than 0.5, and a half-period difference may be present between the first PWM signal VCK1 and the second PWM signal VCK2. That is, the phases of the first PWM signal VCK1 and the second PWM signal VCK2 are complementary to each other.

The rectifying circuit 260 is configured to generate a second control signal VCTRL2 according to the first control signal VCTRL1. The driving auxiliary circuit 280 is configured to generate a driving control signal VDRIVE according to the second control signal VCTRL2, so as to drive the at least one power switch of the power converter 202. In practical applications, the aforementioned output signal may be a DC output voltage VOUT, a corresponding output current, or any signal that is able to respond to the DC output voltage VOUT. A person having ordinary skill in the art may vary the output signal, and the present disclosure is not limited in this regard. For illustrative purposes, the following paragraphs are described with the output signal being the DC output voltage VOUT.

The following paragraphs provide certain embodiments related to the isolated driving circuit 200 to illustrate functions and applications thereof. However, the present disclosure is not limited to the following embodiments.

Reference is made to FIG. 2B. FIG. 2B is a schematic diagram of a power conversion device 200a according to one embodiment of the present disclosure. As shown in FIG. 2B, the power conversion device 200a includes an isolated driving circuit 200 and a power converter 202. In this embodiment, the power converter 202 is an H-bridge power factor corrector (HPFC), but the present disclosure is not limited to this regard.

In this embodiment, the driving auxiliary circuit 280 is configured to generate a driving control signal VDRIVE according to the second control signal VCTRL2 (e.g., a high voltage level), and to turn on the power switch (e.g., power switches Q1 and Q2) of the power converter 202 when the driving control signal VDRIVE is at a first voltage level (i.e., also at a high voltage level). When the second control signal VCTRL2 is at a second voltage level (e.g., a low voltage level), the driving control signal VDRIVE is also at the second voltage level, i.e. at the low voltage level, and the driving auxiliary circuit 280 is configured to electrically couple both control terminals of the power switches Q1 and Q2 to the driving ground GND_P, so as to turn off the power switches Q1 and Q2. In this document, the term “voltage level” may not only be termed as “a certain value of voltage”, but may also be termed as “a range of voltage”. The present disclosure is not limited to this regard, and person skilled in the art may adjust the voltage level in various embodiments according to requirements of the practical application.

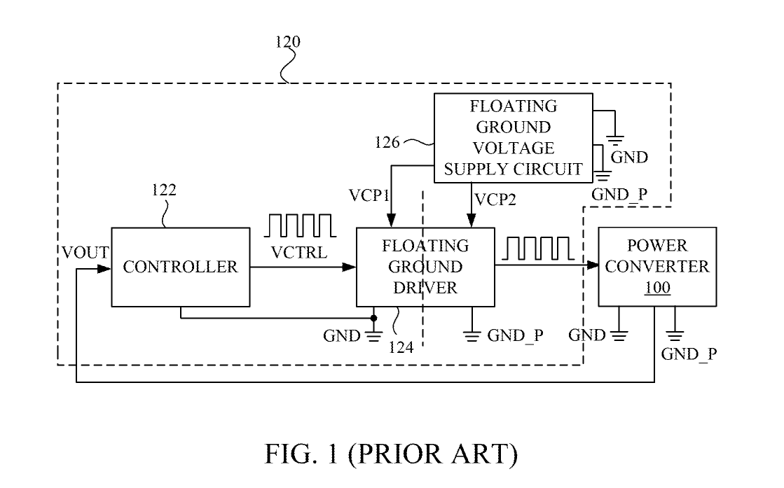

Compared to FIG. 1, in this embodiment, the control module 220 is configured to generate the driving control signal VDRIVE according to the first PWM signal VCK1 and the second PWM signal VCK2 which are complementary to each other, in which the frequency of the first PWM signal VCK1 and the second PWM signal VCK2 is half of the frequency of the driving control signal VDRIVE.

In this embodiment, the driving auxiliary circuit 280 includes resistors R1 and R2, a diode D1, a bias resistor R3, and a switching unit 284. A first terminal of the resistor R1 is configured to receive the second control signal VCTRL2, and a second terminal of the resistor R1 is electrically coupled to a control voltage node N1. A first terminal of the resistor R2 is electrically coupled to the control voltage node N1, and a second terminal of the resistor R2 is electrically coupled to the driving ground GND_P. A first terminal of the diode D1 is electrically coupled to the control voltage node N1, and a second terminal of the diode D1 is electrically coupled to the control terminals of the power switches Q1 and Q2 and is configured to output the driving control signal VDRIVE. In some embodiments, the second terminal of the diode D1 may be electrically coupled to at least one of the control terminals of the power switches. A first terminal of the bias resistor R3 is electrically coupled to the second terminal of the diode D1. A first terminal of the switching unit 284 is electrically coupled to a second terminal of the bias resistor R3, a second terminal of the switching unit 284 is electrically coupled to the driving ground GND_P, and a control terminal of the switching unit 284 is electrically coupled to the control voltage node N1.

For example, when a voltage level of the second control signal VCTRL2 is at the high voltage level, the second control signal VCTRL2 is transmitted to the control voltage node N1 through the resistor R1, and the voltage level of the control voltage node N1 is increased. The diode D1 is thus turned on. In the meantime, the driving control signal VDRIVE generated from the driving auxiliary circuit 280 is also at the high voltage level, and the power switches Q1 and Q2 are thus turned on.

And, when the voltage level of the second control signal VCTRL2 is at the low voltage level, the voltage level of the control voltage node N1 is decreased, and the switching unit 284 is thus turned on. In the meantime, the driving control signal VDRIVE generated from the driving auxiliary circuit 280 is also at the low voltage level, and the control terminals of the power switches Q1 and Q2 are thus electrically coupled to the driving ground GND_P, so as to turn off the power switches Q1 and Q2. In the embodiments above, the switching unit 284 may include a transistor or any analogous switching element. A person having ordinary skill in the art may choose any type circuit depending on the particular application, and the present disclosure is not limited in this regard.

Further, as shown in FIG. 2B, the transformer 240 includes a primary side winding NP and a secondary side winding NS. A first terminal of the primary side winding NP is configured to receive the first PWM signal VCK1, and a second terminal of the primary side winding NP is configured to receive the second PWM signal VCK2. The secondary side winding NS is configured to magnetically couple the primary side winding NP to generate the first control signal VCTRL1. The rectifying circuit 260 may be a full-wave rectifier and the rectifying circuit 260 is configured to generate the second control signal VCTRL2 by rectifying the first control signal VCTRL1. It is noted that the primary side winding NP of the transformer 240 and the control module 220 are electrically coupled to the reference ground GND, and the secondary side winding NS of the transformer 240, the rectifying circuit 260 and the driving auxiliary circuit 280 are electrically coupled to the driving ground GND_P, and thus isolated driving of the power converter 202 is able to be achieved.

Reference is made to FIG. 2B and FIG. 2C. FIG. 2C is a graph illustrating the waveforms of the first control signal VCTRL1 and the second control signal VCTRL2 according to one embodiment of the present disclosure. For illustration, as shown in FIG. 2B and FIG. 2C, when the frequency of the driving control signal is f, the transformer 240 is able to generate the first control signal VCTRL1 with three levels according to the first PWM signal VCK1 and the second PWM signal VCK2, in which the frequency of the first PWM signal VCK1 and the second PWM signal VCK2 is f/2. The rectifying circuit 260 rectifies the first control signal VCTRL1 to generate the second control signal VCTRL2 having the frequency of f, and transmits the second control signal VCTRL2 to the driving auxiliary circuit 280, so as to drive the power switches Q1 and Q2.

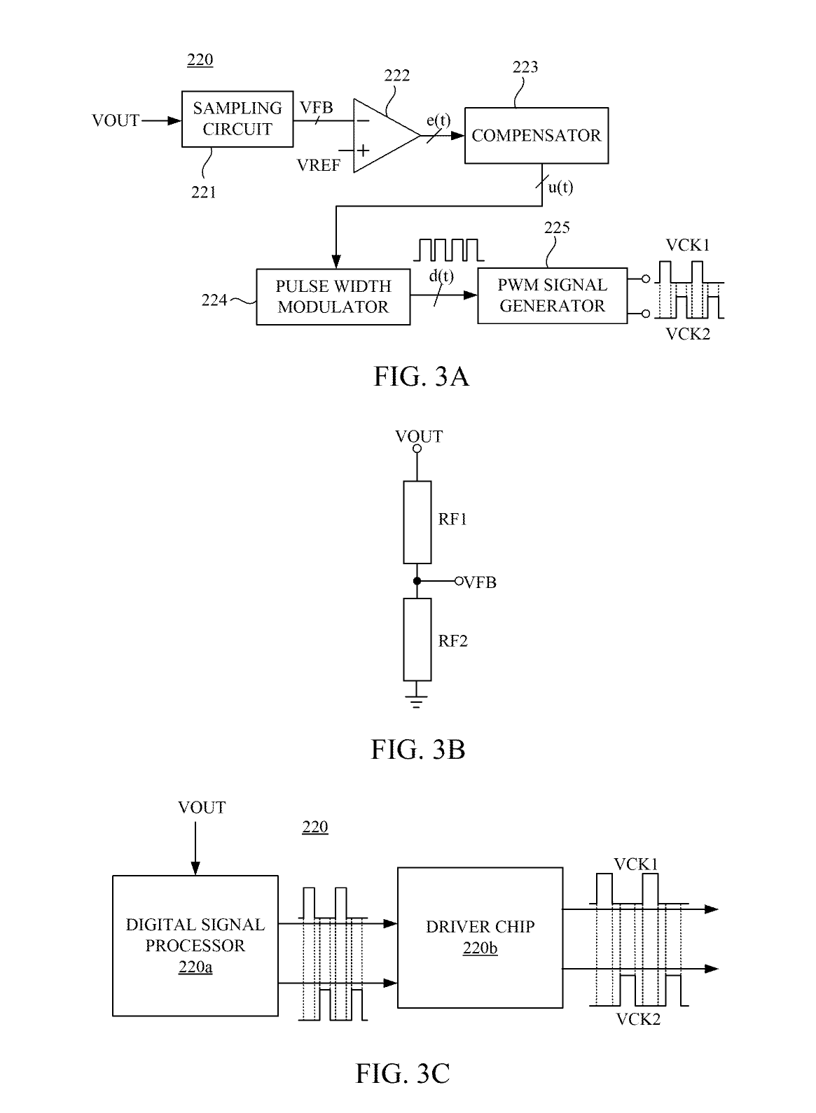

Reference is made to FIG. 3A and FIG. 3B. FIG. 3A is a schematic diagram of the control module 220 according to one embodiment of the present disclosure. FIG. 3B is a schematic diagram of a sampling circuit 221 according to one embodiment of the present disclosure. As shown in FIG. 3A, the control module 220 includes a sampling circuit 221, an error amplifier 222, a compensator 223, a pulse width modulator 224, and a PWM signal generator 225. The sampling circuit 221 is configured to generate a feedback voltage VFB according to the output signal (i.e., the DC output voltage VOUT). For illustration, as shown in FIG. 3B, the sampling circuit 221 includes a sampling resistor RF1 and a sampling resistor RF2. A first terminal of the sampling resistor RF1 is configured to receive the output signal (i.e., the DC output voltage VOUT), and a second terminal of the sampling resistor RF1 is configured to output the feedback voltage VFB. A first terminal of the sampling resistor RF2 is electrically coupled to the second terminal of the sampling resistor RF1, and a second terminal of the sampling resistor RF2 is electrically coupled to the reference ground GND. In other words, the feedback voltage VFB may be generated by dividing the voltage across the sampling resistors RF1 and RF2.

The error amplifier 222 is configured to generate an error signal e(t) according to the feedback voltage VFB and a reference voltage VREF. The compensator 223 is configured to generate a pulse control signal u(t) according to the error signal e(t). For illustration, the compensator 223 is may be a proportional-integral-derivative (PID) controller, which is able to generate the pulse control signal u(t) according to the error signal e(t) and predetermined parameters of the compensator 223. The pulse width modulator 224 is configured to generate a pulse signal d(t) according to the pulse control signal u(t). The PWM signal generator 225 is configured to generate the first PWM signal VCK1 and the second PWM signal VCK2 according to the pulse signal d(t). For illustration, the PWM signal generator 225 may be a phase splitter, which is able to divide the pulse signal d(t) into two signals having complementary phases (i.e., the first PWM signal VCK1 and the second PWM signal VCK2). With such a configuration, the power conversion device 200a is able to generate a steady output signal (e.g., the DC output voltage VOUT) with the feedback control of the control module 220.

Reference is made to FIG. 3C. FIG. 3C is a schematic diagram of the control module according to one embodiment of the present disclosure. As shown in FIG. 3C, in one embodiment, the control module 220 includes a digital signal processor 220a and a driver chip 220b. The digital signal processor 220a is configured to control the driver chip 220b according to the output signal (e.g., the DC output voltage VOUT), so as to make the driver chip 220b generate the first PWM signal VCK1 and the second PWM signal VCK2. A person having ordinary skills in the art may determine ways in which to realize the control module 220 depending on the particular application, and the present disclosure is not limited in this regard.

In various embodiments of the present disclosure, the isolated driving circuit 200 is applied to the power converter 202 having the driving ground GND_P and the reference ground GND. For illustration, the power converter 202 in FIG. 2A may be the aforementioned HPFC in FIG. 2B or a buck converter 202a shown in FIG. 2D.

For example, as shown in FIG. 2B, the HPFC (i.e., the power converter 202) may include an output capacitor CO and a switching circuit 204. A first terminal of the output capacitor CO is configured to output the output signal (e.g., the DC output voltage VOUT), and a second terminal of the output capacitor CO is electrically coupled to the reference ground GND. An input terminal of the switching circuit 204 receives the input signal VIN (in this example, the input signal VIN is an AC signal). The switching circuit 204 includes the aforementioned power switches Q1 and Q2. The first terminals of the power switches Q1 and Q2 are electrically coupled to the driving ground GND_P, and the voltage level of the driving ground GND_P during a positive period of the input signal VIN may be different from the voltage level of the driving ground GND_P during a negative period of the input signal VIN.

As shown in FIG. 2B, the switching circuit 204 further includes an inductor L1, and diodes DC1-DC6. The inductor L1 is configured to receive the input signal VIN. A first terminal of the diode DC1 is electrically coupled to the second terminal of the power switch Q2 and the second terminal of the inductor L1. A first terminal of the diode DC2 is electrically coupled to the second terminal of the power switch Q2, and both a second terminal of the diode DC2 and a second terminal of the diode DC1 are electrically coupled to a first terminal of the output capacitor CO. The diode DC3 is electrically coupled between the first terminal of the diode DC1 and the reference ground GND. The diode DC4 is electrically coupled between the driving ground GND_P and the first terminal of the diode DC2. The diode DC5 is electrically coupled between the driving ground GND_P and the first terminal of the diode DC1. The diode DC6 is electrically coupled between the driving ground GND_P and first terminal of the diode DC2. And, the switching circuit 204 may further include a resistor RC1 which is electrically coupled between the driving ground GND_P and the control terminals of the power switches Q1 and Q2.

In operation, during the positive period of the input signal VIN, the inductor L1, the power switches Q1 and Q2, the diodes DC1 and DC4, and the output capacitor CO may form a boost converter and generate the corresponding output signal (e.g., the DC output voltage VOUT). When the power switches Q1 and Q2 are turned on, the AC current (not shown) generated by the input signal VIN flows through the inductor L1 and the power switches Q1 and Q2 to generate the output signal. When the power switches Q1 and Q2 are turned off, the AC current flows through the inductor L1, the diode DC1, the output capacitor CO, and the diode DC4 to generate the output signal. In practical applications and for example, the diode DC4 may be a diode having a slow recovery time, and thus, when the power switches Q1 and Q2 are turned on, the driving ground GND_P is able to be electrically coupled to the reference ground GND.

During the negative period of the input signal VIN, the inductor L1, the power switches Q1 and Q2, the diodes DC2 and DC3, and the output capacitor CO may form a boost converter and generate the corresponding output signal (e.g., the DC output voltage VOUT). When the power switches Q1 and Q2 are turned on, the AC current (not shown) generated by the input signal VIN flows through the inductor L1 and the power switches Q1 and Q2 to generate the output signal. When the power switches Q1 and Q2 are turned off, the AC current flows through the inductor L1, the diode DC2, the output capacitor CO, and the diode DC3 to generate the output signal. In practical applications and for example, the diode DC2 may be a diode having a slow recovery time, and thus, when the power switches Q1 and Q2 are turned on, the driving ground GND_P is able to be electrically coupled to the output terminal (i.e., the positive terminal of the DC output voltage VOUT).

However, the diodes DC4 and DC2 may also be a common diode, etc. During the positive period of the input signal VIN, the driving ground GND_P is coupled to the reference ground GND through the turned-off diode DC4 when the power switches Q1 and Q2 are turned on. During the negative period of the input signal VIN, the driving ground GND_P is electrically coupled to the output terminal through the turned-off diode DC2 when the power switches Q1 and Q2 are turned on. As a result, the voltage level of the driving ground GND_P of the HPFC 202 during the positive period may be different from the voltage level of the driving ground GND_P of the HPFC 202, and thus the driving ground GND_P is floating.

Reference is made to FIG. 2D. FIG. 2D is a schematic diagram of a buck converter 202a according to one embodiment of the present disclosure. Alternatively, as shown in FIG. 2D, the aforementioned power converter 202 includes the buck converter 202a. The buck converter 202a includes an inductor L, a diode D, a capacitor C, and a power switch Q1. A first terminal of the inductor L, a first terminal of the diode D, and the first terminal of the power switch Q1 are electrically coupled to the driving ground GND_P, and a second terminal of the capacitor C and a second terminal of the diode D are electrically coupled to the reference ground GND. The power switch Q1 is configured to be selectively turned on or off according to the driving control signal VDRIVE.

For example, when the power switch Q1 is turned on, the driving ground GND_P is electrically coupled to the output terminal (i.e., the positive terminal of the DC output voltage VOUT). When the power switch Q1 is turned off, the driving ground GND_P is electrically coupled to the reference ground GND. In other words, the voltage level of the driving ground GND_P is varied when the power switch Q1 is turned on and off. As a result, the driving ground GND_P is floating.

In summary, in various embodiments above, the voltage level of the driving ground GND_P is varied during the positive period and the negative period of the input signal VIN, and the voltage level of the driving ground GND_P is varied when the power switches Q1 and Q2 are turned on and off. Therefore, the voltage level of the driving ground GND_P is floating.

The arrangements shown in each power converter are given for illustrative purposes. Other arrangements are within the contemplated scope of the present disclosure. A person having ordinary skill in the art may utilize any type of power converter, and the present disclosure is not limited in this regard.

Another aspect of the present disclosure provides an isolated driving circuit for driving a power converter having a driving ground and a reference ground. The power converter includes at least one power switch which is electrically coupled to the driving ground, such as the power switches Q1 and Q2 of the power converter 202 in FIG. 2B.

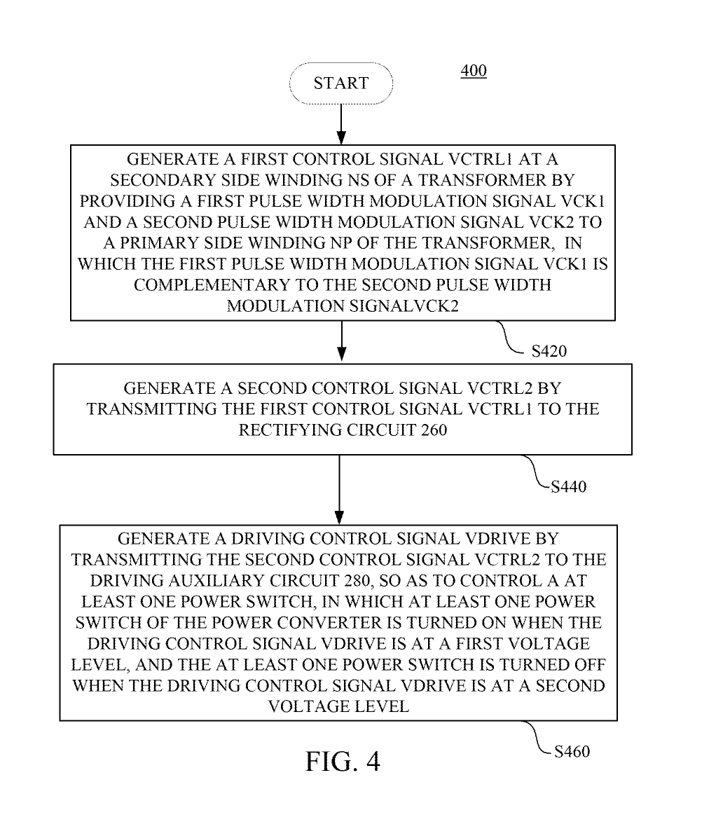

Reference is made to FIG. 4. FIG. 4 is a flow chart of an isolated driving method 400 according to one embodiment of the present disclosure. As shown in FIG. 4, the isolated driving method includes step S420, step S440 and step S460.

In step S420, a first control signal VCTRL1 is generated at the secondary side winding NS of a transformer by providing a first PWM signal VCK1 and a second PWM signal VCK2 to the primary side winding NP of the transformer, in which the first PWM signal VCK1 and the second PWM signal VCK2 are complementary to each other. For illustration, as shown in FIG. 2B, the first PWM signal VCK1 and the second PWM signal VCK2 are generated and transmitted to the transformer 240 by a control module 220 according to the output signal (e.g., the DC output voltage) which is outputted from the HPFC 202, so as to generate the first control signal VCTRL1.

In step S440, a second control signal VCTRL2 is generated by transmitting the first control signal VCTRL1 to the rectifying circuit 260.

In step S460, a driving control signal VDRIVE is generated to control the at least one power switch by transmitting the second control signal VCTRL2 to the driving auxiliary circuit 280. Specifically, in some embodiments, when the voltage level of the second control signal VCTRL2 is at a first voltage level, the driving control signal VDRIVE is also at the first voltage level, and the at least one power switch of the power converter is turned on. When the voltage level of the second control signal VCTRL2 is at a second voltage level, the driving control signal VDRIVE is also at the second voltage level, a control terminal of the at least one power switch is electrically coupled to the driving ground GND_P, and the at least one power switch is thus turned off. For illustration, as shown in FIG. 2B, the rectifying circuit 260 rectifies the first control signal VCTRL1 and generates the second control signal VCTRL2. When the second control signal VCTRL2 is at the high voltage level (i.e., the driving control signal VDRIVE is at the high voltage level), the power switches Q1 and Q2 are turned on. When the second control signal VCTRL2 is at the low voltage level (i.e., the driving control signal VDRIVE is at the low voltage level), the control terminals of the power switches Q1 and Q2 are electrically coupled to the driving ground GND_P, and the switches Q1 and Q2 are thus turned off.

In summary, the power conversion device, the isolated driving circuit, and the method thereof in the present disclosure may be able to drive the power converter having floating driving ground without an additional floating ground voltage supply circuit. As a result, the cost and complexity of the circuitry of the power conversion device are reduced.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the invention. In view of the foregoing, it is intended that the present disclosure cover modifications and variations of this invention provided they fall within the scope of the following claims.

What is claimed is:

1. An isolated driving circuit for driving a power converter, wherein the power converter comprises a driving ground, a reference ground and at least one power switch, the power converter being configured to generate an output signal according to an input signal, the output signal being electrically coupled to the reference ground, and the at least one power switch being electrically coupled to the driving ground, the isolated driving circuit comprising:
a control module configured to generate a first pulse width modulation signal and a second pulse width modulation signal according to the output signal;
a transformer configured to receive the first pulse width modulation signal and the second pulse width modulation signal to generate a first control signal;
a rectifying circuit configured to generate a second control signal according to the first control signal; and
a driving auxiliary circuit configured to generate a driving control signal according to the second control signal, so as to drive the at least one power switch.

2. The isolated driving circuit of claim 1, wherein a voltage level of the driving ground is varied when the at least one power switch is turned on and off, or the voltage level of the driving ground is varied during a positive period and a negative period of the input signal when the input signal is an AC signal.

3. The isolated driving circuit of claim 1, wherein when a voltage level of the driving control signal is at a first voltage level, the driving auxiliary circuit turns on the at least one power switch by the driving control signal, and when the voltage level of the driving control signal is at a second voltage level, the driving auxiliary circuit turns off the at least one power switch by the driving control signal.

4. The isolated driving circuit of claim 3, wherein the driving auxiliary circuit comprises:
a diode, a first terminal of the diode being electrically coupled to a control voltage node, and a second terminal of the diode being electrically coupled to a control terminal of the at least one power switch;
a bias resistor, a first terminal of the bias resistor being electrically coupled to the second terminal of the diode; and
a switching unit, a first terminal of the switching unit being electrically coupled to a second terminal of the bias resistor, a second terminal of the switching unit being electrically coupled to the driving ground, and a control terminal of the switching unit being electrically coupled to the control voltage node.

5. The isolated driving circuit of claim 4, wherein the driving auxiliary circuit further comprises:
a first resistor, a first terminal of the first resistor being configured to receive the second control signal, and a second terminal of the first resistor being electrically coupled to the control voltage node; and
a second resistor, a first terminal of the second resistor being electrically coupled to the control voltage node, and a second terminal of the second resistor being electrically coupled to the driving ground.

6. The isolated driving circuit of claim 1, wherein the frequency of the first pulse width modulation signal and the frequency of the second pulse width modulation signal are half of the frequency of the driving control signal, and the first pulse width modulation signal is complementary to the second pulse width modulation signal.

7. The isolated driving circuit of claim 1, wherein the control module comprises:
a sampling circuit configured to generate a feedback voltage according to the output signal;
an error amplifier configured to generate an error signal according to the feedback voltage and a reference voltage;
a compensator configured to generate a pulse control signal according to the error signal;
a pulse width modulator configured to generate a pulse signal according to the pulse control signal; and
a pulse width modulation signal generator configured to generate the first pulse width modulation signal and the second pulse width modulation signal according to the pulse signal.

8. The isolated driving circuit of claim 1, wherein the control module comprises a digital signal processor and a driver chip, the digital signal processor being configured to control the driver chip to generate the first pulse modulation signal and the second pulse modulation signal according to the output signal.

9. The isolated driving circuit of claim 1, wherein the transformer comprises:
a primary side winding, a first terminal of the primary side winding being configured to receive the first pulse width modulation signal, and a second terminal of the primary side winding being configured to receive the second pulse width modulation signal; and
a secondary side winding magnetically coupled to the primary side winding and configured to generate the first control signal.

10. The isolated driving circuit of claim 1, wherein the power converter comprises a buck converter or an H-bridge power factor corrector.

11. A power conversion device, comprising:
a power converter configured to generate an output signal according to an input signal, the power converter comprising a driving ground, a reference ground and at least one power switch, wherein the output signal is electrically coupled to the reference ground, and the at least one power switch is electrically coupled to the driving ground; and
an isolated driving circuit configured to generate a driving control signal according to the output signal, so as to drive the at least one power switch,
wherein when the voltage level of the driving control signal is at a first voltage level, the at least one power switch is turned on, and when the voltage level of the driving control signal is at a second voltage level, the at least one power switch is turned off.

12. The power conversion device of claim 11, wherein the isolated driving circuit comprises:
a control module configured to generate a first pulse width modulation signal and a second pulse width modulation signal according to the output signal;
a transformer configured to receive the first pulse width modulation signal and the second pulse width modulation signal to generate a first control signal;
a rectifying circuit configured to generate a second control signal according to the first control signal; and
a driving auxiliary circuit configured to generate the driving control signal to a control terminal of the at least one power switch according to the second control signal, so as to drive the at least one power switch.

13. The power conversion device of claim 12, wherein the driving auxiliary circuit comprises:
a first resistor, a first terminal of the first resistor being configured to receive the second control signal, and a second terminal of the first resistor being electrically coupled to a control voltage node;
a second resistor, a first terminal of the second resistor being electrically coupled to the control voltage node, and a second terminal of the second resistor being electrically coupled to the driving ground;
a diode, a first terminal of the diode being electrically coupled to the control voltage node, and a second terminal of the diode being electrically coupled to the control terminal of the at least one power switch;
a bias resistor, a first terminal of the bias resistor being electrically coupled to the second terminal of the diode; and
a switching unit, a first terminal of the switching unit being electrically coupled to a second terminal of the bias resistor, a second terminal of the switching unit being electrically coupled to the driving ground, and a control terminal of the switching unit being electrically coupled to the control voltage node.

14. The power conversion device of claim 12, wherein the control module comprises:
a sampling circuit configured to generate a feedback voltage according to the output signal;
an error amplifier configured to generate an error signal according to the feedback voltage and a reference voltage;
a compensator configured to generate a pulse control signal according to the error signal;
a pulse width modulator configured to generate a pulse signal according to the pulse control signal; and
a pulse width modulation signal generator configured to generate the first pulse width modulation signal and the second pulse width modulation signal according to the pulse signal.

15. The power conversion device of claim 14, wherein the sampling circuit comprises:
a first sampling resistor, a first terminal of the first sampling resistor being configured to receive the output signal, and a second terminal of the first sampling resistor being configured to generate the feedback voltage; and
a second sampling resistor, a first terminal of the second sampling resistor being electrically coupled to the second terminal of the first sampling resistor, and a second terminal of the second sampling resistor being electrically coupled to the reference ground.

16. The power conversion device of claim 12, wherein the frequency of the first pulse width modulation signal and the frequency of the second pulse width modulation signal are half of the frequency of the driving control signal, and the first pulse width modulation signal is complementary to the second pulse width modulation signal.

17. The power conversion device of claim 12, wherein the control module comprises a digital signal processor and a driver chip, the digital signal processor being configured to control the driver chip to generate the first pulse modulation signal and the second pulse modulation signal according to the output signal.

18. The power conversion device of claim 12, wherein the transformer comprises:
a primary side winding, a first terminal of the primary side winding being configured to receive the first pulse width modulation signal, and a second terminal of the primary side winding being configured to receive the second pulse width modulation signal; and
a secondary side winding magnetically coupled to the primary side winding and configured to generate the first control signal.

19. The power conversion device of claim 11, wherein the power converter is an H-bridge power factor corrector, the H-bridge power factor corrector comprising a switching circuit and an output capacitor, wherein a first terminal of the output capacitor is configured to output the output signal, a second terminal of the output capacitor is electrically coupled to the reference ground, and an input terminal of the switching circuit is configured to receive the input signal.

20. The power conversion device of claim 19, wherein the switching circuit comprises:
a first power switch;
a second power switch, a first terminal of the first power switch and a first terminal of the second power switch being electrically coupled to the driving ground;
an inductor configured to receive the input signal;
a first diode, a first terminal of the first diode being electrically coupled to both the inductor and a second terminal of the first power switch;
a second diode, a first terminal of the second diode being electrically coupled to a second terminal of the second power switch, and both a second terminal of the first diode and a second terminal of the second diode being electrically coupled to the first terminal of the output capacitor;
a third diode electrically coupled between the first terminal of the first diode and the reference ground;
a fourth diode electrically coupled between the first terminal of the second diode and the reference ground;
a fifth diode electrically coupled between the driving ground and the first terminal of the first diode;
a sixth diode electrically coupled to the driving ground and the first terminal of the second diode; and
a resistor electrically coupled to the driving ground and a control terminal of the first power switch.

21. The power conversion device of claim 11, wherein the power converter is a buck converter, the buck converter comprising an inductor, a diode, a capacitor and a power switch, wherein a first terminal of the inductor, a first terminal of the diode and a first terminal of the power switch are electrically coupled to the driving ground, and a second terminal of the capacitor and a second terminal of the diode are electrically coupled to the reference ground.

22. An isolated driving method for driving a power converter having a driving ground and a reference ground, wherein the power converter comprises at least one power switch electrically coupled to the driving ground, the isolated method comprising:
generating a first control signal at a secondary side winding of a transformer by providing a first pulse width modulation signal and a second pulse width modulation signal to a primary side winding of the transformer, wherein the first pulse width modulation signal is complementary to the second pulse width modulation signal;
generating a second control signal by transmitting the first control signal to a rectifying circuit; and
generating a driving control signal by transmitting the second control signal to a driving auxiliary circuit, so as to control the at least one power switch, wherein when the voltage level of the driving control signal is at a first voltage level, the at least one power switch is turned on, and when the voltage level of the driving control signal is at a second voltage level, the at least one power switch is turned off.

23. The isolated driving method of claim 22, further comprising:
providing a control module to generate the first pulse modulation signal and the second pulse modulation signal according to an output signal outputted from the power converter, wherein a frequency of the first pulse modulation signal and the second pulse modulation signal is half of the frequency of the driving control signal.
